(19) United States
(12) Patent Application Publication
(10) Pub. No.: US 2016/0375570 A1
(43) Pub. Date: Dec. 29, 2016

(54) Machine Tool Device

(71) Applicant: Robert Bosch GmbH, Stuttgart (DE)

(72) Inventors: Cornelius Boeck, Kirchheim (DE); Daniel Barth, Leinfelden-Echterdingen (DE); Joachim Schadow, Stuttgart (DE); Joerg Maute, Sindelfingen (DE); Joern Stock, Bempflingen (DE); Florian Esenwein, Leinfelden-Echterdingen (DE); Manfred Lutz, Filderstadt (DE)

(73) Assignee: Robert Bosch GmbH, Stuttgart (DE)

(21) Appl. No.: 15/114,342

(22) PCT Filed: Feb. 25, 2015
(86) PCT No.: PCT/EP2015/053933

§ 371 Date: Jul. 26, 2016

(30) Foreign Application Priority Data
May 13, 2014 (DE) 10 2014 209 009.1

(51) Int. Cl. B25F 5/00; B24B 23/02; G05B 19/4062; B25B 23/147; B23Q 11/00; B23D 59/00; B25D 11/00

(52) U.S. Cl. CPC B25F 5/00; B23D 59/001; B24B 23/028; B25D 11/00; B25B 23/147; B23Q 11/0078; G05B 19/4062; B25D 2250/195; B25D 2250/221; G05B 2219/42113

(57) ABSTRACT

A machine tool device includes at least one open-loop and/or closed-loop control unit and at least one drive-unit sensor unit configured to sense at least one drive-unit characteristic value, which can be processed by the open-loop and/or closed-loop control unit at least for open-loop and/or closed-loop control of a drive unit of a machine tool and/or for an output of information to an operator. The machine tool device further includes at least one processing-tool sensor unit configured to sense at least one processing-tool characteristic value, which can be processed by the open-loop and/or closed-loop control unit at least for open-loop and/or closed-loop control of the drive unit and/or for an output of information to an operator.

### PRIOR ART

US 2013/0187587 A1 already discloses a power tool device, in particular a handheld power tool device, which comprises an open-loop and/or closed-loop control unit and a drive unit sensor unit for recording at least one drive unit characteristic variable, wherein the drive unit characteristic variable can be processed by the open-loop and/or closed-loop control unit for providing an open-loop and/or closed-loop control of a drive unit of a power tool and/or for providing an output of information to an operator.

### DISCLOSURE OF THE INVENTION

The invention is based on a power tool device, in particular on a handheld power tool device, with at least one open-loop and/or closed-loop control unit and with at least one drive unit sensor unit for recording at least one drive unit characteristic variable, which can be processed by the open-loop and/or closed-loop control unit at least for providing an open-loop and/or closed-loop control of a drive unit of a power tool and/or for providing an output of information to an operator.

It is proposed that the power tool device comprises at least one machining tool sensor unit for recording at least one machining tool characteristic variable, which can be processed by the open-loop and/or closed-loop control unit at least for providing an open-loop and/or closed-loop control of the drive unit and/or for providing an output of information to an operator. The open-loop and/or closed-loop control unit is at least preferably intended for controlling the drive unit in an open-loop and/or closed-loop manner in dependence on the at least one drive unit characteristic variable recorded by the drive unit sensor unit and in dependence on the at least one machining tool characteristic variable recorded by means of the machining tool sensor unit. In addition, the open-loop and/or closed-loop control unit is preferably intended at least for outputting to an operator information in dependence on the at least one drive unit characteristic variable recorded by means of the drive unit sensor unit and in dependence on the at least one machining tool characteristic variable recorded by means of the machining tool sensor unit. Preferably, at least one drive unit characteristic curve, a maximum rotational speed, a minimum rotational speed, a maximum torque and/or a minimum torque of the drive unit can be controlled in an open-loop and/or closed-loop manner by means of the open-loop and/or closed-loop control unit. An “open-loop and/or closed-loop control unit” is to be understood in particular as meaning a unit with at least one set of control electronics. “Control electronics” is to be understood in particular as meaning a unit with a processor unit and with a memory unit and also with an operating program stored in the memory unit. “Intended” is to be understood in particular as meaning specifically programmed, specifically designed and/or specifically equipped. Saying that an element and/or a unit is/are intended for a specific function is to be understood in particular as meaning that the element and/or the unit fulfills/fulfill and/or performs/perform this specific function in at least one application state and/or operating state.

The drive unit sensor unit is preferably intended for recording at least one drive unit characteristic variable of a drive unit formed as an electric motor unit, in particular as a brushless electric motor unit. Consequently, the drive unit sensor unit is preferably formed as an EC electric motor drive unit sensor unit. The drive unit characteristic variable may be formed here as a drive unit current, as a drive unit voltage, as a drive unit angle of rotation, as an electrical drive unit resistance, as a drive unit magnetic field characteristic variable, as an electromotive force characteristic variable of the drive unit, as a drive unit rotational speed, as a drive unit torque, as a drive unit angular velocity, as a drive unit rotor position, as a drive unit direction of rotation, as a drive unit temperature or as a further drive unit characteristic variable that appears appropriate to a person skilled in the art. The drive unit characteristic variable is preferably different from a straightforward switch actuation of a switch by an operator. The drive unit sensor unit comprises at least one drive unit sensor element for recording the at least one drive unit characteristic variable. The drive unit sensor element may be formed here as a drive unit current sensor, as a drive unit voltage sensor, as a drive unit angle of rotation sensor, as an electrical drive unit resistance sensor, as a drive unit magnetic field sensor, as an electromotive force characteristic variable sensor, as a drive unit rotational speed sensor, as a drive unit torque sensor, as a drive unit angular speed sensor, as a drive unit rotor position sensor, as a drive unit direction of rotation sensor, as a drive unit temperature sensor or as a further drive unit sensor element that appears appropriate to a person skilled in the art.

An information output unit for providing an output of information to an operator is preferably formed as an optical, acoustic and/or haptic information output unit. Here, the information output unit is preferably a component part of the power tool device. It is however also conceivable that the information output unit is a component part of a power tool comprising the power tool device or a component part of an external unit, such as for example a smartphone, a tablet, a PC, a laptop or the like. For providing an output of information to an operator, the information output unit preferably comprises at least one optical output unit, such as for example an LC display, a touch-sensitive display, an LED display, a plasma display or the like for providing an optical output of information to an operator. Preferably, the information output unit comprises at least one acoustic output unit, such as for example a loudspeaker or the like, for providing an acoustic output of information to an operator. Particularly preferably, the information output unit comprises at least one haptic output unit, such as for example a vibration exciter unit or the like, for providing a haptic output of information to an operator. It is however also conceivable that an output of information to an operator takes place as a result of an activation of the drive unit by means of the open-loop and/or closed-loop control unit. It is conceivable here that an output of information to an operator takes place for example due to a fluctuation in rotational speed of a drive unit rotational speed or the like. Further drive-unit-related information outputs to an operator that appear appropriate to a person skilled in the art are likewise conceivable.

The machining tool sensor unit is preferably intended for recording at least one machining tool characteristic variable of a machining tool arranged in a tool holder. The tool holder is preferably a component part of a power tool comprising the power tool device. It is however also conceivable that the tool holder is a component part of the power tool device. The machining tool characteristic variable may be formed here as a machining tool mass, as a machining tool dimension, as a machining tool vibration, as a machining tool speed, as a machining tool rotational speed, as a machining tool inertia, as a machining tool type, as a machining tool temperature, as a machining tool degree of contamination, as a machining tool cutting edge wear, or as some other machining tool characteristic variable that appears appropriate to a person skilled in the art. The machining tool sensor unit comprises at least one machining tool sensor element for recording the at least one machining tool characteristic variable. The machining tool sensor element may be formed here as a machining tool mass sensor, as a machining tool dimension sensor, as a machining tool vibration sensor, as a machining tool speed sensor, as a machining tool rotational speed sensor, as a machining tool inertia sensor, as a machining tool type sensor, as a machining tool temperature sensor, as a machining tool degree of contamination sensor, as a machining tool cutting edge wear sensor or some other machining tool sensor element that appears appropriate to a person skilled in the art.

Preferably, at least when running up the drive unit to an idling speed, at least one drive unit characteristic variable and/or at least one machining tool characteristic variable can be determined by means of the open-loop and/or closed-loop control unit. Vibrations of a machining tool can preferably be recorded here by means of at least one machining tool sensor element, which is formed as an acceleration sensor, wherein the recorded signals can be evaluated by means of the open-loop and/or closed-loop control unit. Moreover, a machining tool characteristic variable that can be processed by the open-loop and/or closed-loop control unit for providing a determination of a machining tool dimension can preferably be recorded by means of at least one further machining tool sensor element, which is formed as an optical sensor (camera, infrared sensor etc.) or as a distance sensor. Moreover, a motor current can preferably be recorded by means of a drive unit sensor element during running up of the drive unit to an idling speed, which can be processed by means of the open-loop and/or closed-loop control unit for providing a determination of an inertia of a machining tool. Furthermore, a machining tool type of a machining tool can be determined by means of the open-loop and/or closed-loop control unit by means of at least one recorded machining tool characteristic variable, wherein parameters can be changed machining-tool-specifically for providing an open-loop and/or closed-loop control of the drive unit, such as for example a setting of a rotational speed for stainless steel applications when a stainless steel machining tool is detected on a portable power tool formed as an angle grinder, a soft start when a polishing machining tool is detected or activation of a deceleration function of a portable power tool when a cutting machining tool is detected, such as for example a cutting disk in the case of a portable power tool formed as an angle grinder. In addition to recording at least one machining tool characteristic variable by means of the machining tool sensor unit, a transmission of at least one machining tool characteristic variable by means of an RFID, a barcode, a data matrix code or the like is also conceivable. This advantageously allows there to be a clear identification of a machining tool type and/or a tool type, for which there are stored in the memory unit of the open-loop and/or closed-loop control unit machining-tool-specific parameters, which as a result of a recording of at least one machining tool characteristic variable by the machining tool sensor unit can be adapted by means of the open-loop and/or closed-loop control unit, such as for example to a degree of wear, to a degree of imbalance etc.

Electronic data exchange between the open-loop and/or closed-loop control unit and the drive unit sensor unit and/or the machining tool sensor unit preferably takes place in a wire-bound manner. In an alternative configuration of the power tool device, an electronic data exchange between the open-loop and/or closed-loop control unit and the drive unit sensor unit and/or the machining tool sensor unit takes place in a cableless manner, such as for example by means of a Bluetooth connection, by means of a WLAN connection, by means of an NFC connection, by means of an infrared connection or the like. The open-loop and/or closed-loop control unit controls the drive unit in an open-loop and/or closed-loop manner particularly preferably at least in dependence on the drive unit characteristic variable recorded by means of the drive unit sensor unit and the machining tool characteristic variable recorded by means of the machining tool sensor unit. Further characteristic variables that appear appropriate to a person skilled in the art and for which allowance can be made by the open-loop and/or closed-loop control unit for providing an open-loop and/or closed-loop control of the drive unit are likewise conceivable.

By means of the configuration of the power tool device according to the invention, damage to a machining tool can be advantageously detected, in particular before a workpiece is machined with the machining tool. For example, vibrations can be advantageously recorded and a corresponding warning issued to an operator if the vibrations exceed a critical value and/or an open-loop and/or closed-loop control of the drive unit can be adapted to a damaged machining tool. Consequently, a risk of an operator being injured can be advantageously kept down. Moreover, inadmissibly or incorrectly mounted machining tools can be advantageously detected.

In an advantageous configuration of the power tool device, in at least one operating mode the open-loop and/or closed-loop control unit processes the at least one machining tool characteristic variable recorded by means of the machining tool sensor unit for providing a determination of a tool type of a machining tool arranged on a tool holder of the power tool. Consequently, a tool type of a machining tool arranged on the tool holder of the power tool can preferably be identified by means of the power tool device on the basis of its characteristic influence on a tool-related behavior of the power tool. The power tool device is preferably intended here for recording by means of at least one acceleration sensor or by means of a number of acceleration sensors of the machining tool sensor unit a vibration (natural oscillation) of the machining tool and additionally recording an acceleration moment during a run-up to an idling speed of the drive unit and/or the machining tool. From these data, the power tool device infers the use of for example a drill bit with a detected diameter x and sets an optimum rotational speed, an optimum number of percussions, or in the case of a configuration of the power tool as a hammer drill a release moment of an overload clutch so as to correspond to the values for an optimum rate of work progress. Going further, it is conceivable that the power tool device further adapts the previously set control parameters of the drive unit as a result of a reference run, such as for example by a drilling depth detection for instance, in which the rate of work progress within a defined time is detectable, wherein a material (concrete, gypsum, brick, etc.) of a workpiece being machined can be inferred from a combination of a rate of progress of the work and a determination of the type of tool. It is additionally conceivable that the power tool device identifies a tool type of a machining tool arranged on the tool holder of the power tool on the basis of an information carrier (BARCODE, DATA Matrix, RFID, NFC, etc.) arranged on the machining tool and/or makes possible an adjustment of the machining tool characteristic variable recorded by means of the machining tool sensor unit and a parameter output by the information carrier. For this purpose, preferably already during the mounting of the machining tool (for example a roughing disk, cutting disk, serrated disk etc. in the case of a configuration of the power tool as an angle grinder) and/or after supplying current to the drive unit of the power tool, the power tool device records, by way for example of NFC, a tool type, a diameter of the machining tool, a maximum rotational speed that is admissible for the machining tool or other tool-specific characteristics of the machining tool. These data can be used to make inferences for example with respect to a kickback stop setting, a maximum and/or minimum rotational speed, a setting of an overload protection, speed invariability etc., and the drive unit can be set correspondingly by means of the power tool device. By means of the configuration according to the invention, an adaptation of an open-loop and/or closed-loop control of the drive unit can advantageously be made to a machining tool arranged on the tool holder of the power tool.

The open-loop and/or closed-loop control unit advantageously comprises at least one memory unit, in which at least one setting parameter that is dependent at least on at least one previous machining of a workpiece can be stored for providing an open-loop and/or closed-loop control of the drive unit. In the memory unit, a setting history that was used in the case of previous machinings of workpieces can preferably be stored. By means of the setting history stored in the memory unit, preferably the most likely setting for future machinings can be determined and characteristic variables can be prescribed as default values. For example, a power tool formed as an angle grinder has been used in five previous applications, once for cutting a workpiece and four times for grinding. In the case of the cutting, for example, a kickback stop function is set to sensitive, a rotational speed is set high and an overload protection is set high, so that it is only triggered when there is a high overload. In the case of grinding, for example, the kickback stop function is in turn deactivated and the overload protection is set low, so that it is triggered when there is a small overload. Since in the previous cases of machining the power tool was used more often for grinding, default values for grinding for example are automatically set by means of the power tool device when the power tool is switched on. Moreover, the power tool device is preferably intended for storing in the memory unit parameters for providing an open-loop and/or closed-loop control of the drive unit in dependence on an initial learning operating mode. Here, the power tool device learns during the initial learning operating mode what is required, sets parameters correspondingly for providing an open-loop and/or closed-loop control of the drive unit and reproduces this during a reference operating mode. For example, a power tool device arranged in a power tool formed as a jigsaw has for this purpose at least one displacement sensor, at least one rotational speed sensor and at least one acceleration sensor. During the initial learning operating mode, a cut is first scored at a slow rotational speed and the rotational speed is subsequently adapted in order to achieve a rapid rate of work progress. In order to work precisely when sawing out a contour, the rotational speed is reduced in the case of “curved cuts”. By using the at least one displacement sensor, the at least one rotational speed sensor and the at least one acceleration sensor, the power tool device can reproduce at least one speed profile stored in the memory unit on the basis of a calculation of a cut path covered and a transverse acceleration when moving the power tool. Small batch production comprising continually recurring work steps with machining parameters that remain the same can be advantageously made possible. Consequently, a high level of operating convenience can be advantageously achieved by means of the configuration according to the invention.

Furthermore, it is proposed that the power tool device comprises at least one operator sensor unit for recording at least one operator-specific characteristic variable, which can be processed by the open-loop and/or closed-loop control unit at least for providing an open-loop and/or closed-loop control of the drive unit and/or for outputting information to an operator. An “operator-specific characteristic variable” is to be understood in particular as meaning here a characteristic variable that is dependent on a behavior of an operator, such as for example a way in which an operator affects the power tool device, in particular a way in which an operator affects a power tool comprising the power tool device, a level of training of an operator and/or a behavior of an operator when using a power tool comprising the power tool device. The operator-specific characteristic variable may be formed here as an operator pressing force, as an operator advancing force, as an operator training status, as an operator holding force, as an operator-specific type of exposure to stress, as an operator application case, as an operator pressing pressure, as a degree of operator use, such as for example a characteristic variable describing frequent use or infrequent use, as a time of operator use, as operator exposure to stress, such as for example exposure to noise and/or exposure to vibration, as operator access authorization to a location and/or as some other operator-specific characteristic variable that appears appropriate to a person skilled in the art.

By means of the configuration according to the invention, allowance can be advantageously made for an operating behavior for providing open-loop and/or closed-loop control of the drive unit. Here it is conceivable for example that a parameter of a start-up behavior is adaptable to the operator-specific characteristic variable, a drive unit characteristic variable is adaptable to the operator-specific characteristic variable, an impact frequency is adaptable to the operator-specific characteristic variable, an impact energy is adaptable to the operator-specific characteristic variable, an orbital stroke parameter is adaptable to the operator-specific characteristic variable or further parameters or characteristic maps of a drive unit that appear appropriate to a person skilled in the art are adaptable to the operator-specific characteristic variable. Consequently, a risk of an operator being injured and/or of improper operation of a power tool comprising the power tool device can be advantageously kept down. Moreover, an operator may be advantageously assigned to a user group in order to adapt parameters for providing an open-loop and/or closed-loop control of the drive unit to the operator.

It is further proposed that the power tool device comprises at least one workpiece sensor unit for recording at least one workpiece characteristic variable, which can be processed by the open-loop and/or closed-loop control unit at least for providing an open-loop and/or closed-loop control of the drive unit and/or for providing an output of information to an operator. The workpiece sensor unit is preferably intended for recording at least one material of a workpiece. Moreover, the workpiece sensor unit is additionally or alternatively intended for recording a density of a workpiece, a distance of a workpiece relative to a machining tool arranged in a tool holder, a dimension of a workpiece, a position of a workpiece and/or further workpiece characteristic variables that appear appropriate to a person skilled in the art. Consequently, an open-loop and/or closed-loop control of a drive unit that is advantageously made to match a workpiece to be machined and a machining tool arranged in a tool holder can advantageously take place. As a result, precise machining of a workpiece can be advantageously made possible. Moreover, a high rate of work progress can be advantageously made possible.

It is moreover proposed that the power tool device comprises at least one power tool accessory sensor unit for recording at least one power tool accessory characteristic variable, which can be processed by the open-loop and/or closed-loop control unit at least for providing an open-loop and/or closed-loop control of the drive unit and/or for providing an output of information to an operator. A “power tool accessory sensor unit” is to be understood as meaning in particular here a sensor unit that records a characteristic variable of at least one power tool accessory which can be attached to a power tool comprising the power tool device. The power tool accessory characteristic variable may be formed here as an accessory state characteristic variable, such as for example a mounted state characteristic variable of an accessory, a wear state characteristic variable, as an accessory position characteristic variable, as an accessory function characteristic variable, as an accessory dimension characteristic variable or the like. Consequently, allowance for a mounted accessory can be advantageously made in an open-loop and/or closed-loop control of the drive unit by means of the open-loop and/or closed-loop control unit. For example, in the event of an incorrect, defective and/or worn accessory, an output of information to an operator can advantageously take place and/or an open-loop and/or closed-loop control parameter, such as for example a rotational speed, a power supply, a voltage supply or the like, can be advantageously adapted.

Furthermore, it is proposed that the power tool device comprises at least one input unit for an input of at least one machining characteristic variable, which can be processed by the open-loop and/or closed-loop control unit at least for providing an open-loop and/or closed-loop control of the drive unit. The input unit may be formed here as a touch-sensitive display and/or as a key-bound input interface. By means of the input unit, preferably at least a drive unit characteristic curve, a maximum rotational speed, a minimum rotational speed, a maximum torque, a minimum torque can be set by being input by an operator. It is also conceivable that alternatively or additionally machining tool characteristic variables, workpiece characteristic variables, etc. that can be processed by the open-loop and/or closed-loop control unit during open-loop and/or closed-loop control of the drive unit can be input by an operator by means of the input unit. Consequently, active intervention by an operator in an open-loop and/or closed-loop control of the drive unit can be advantageously achieved.

Furthermore, it is proposed that the power tool device comprises at least one communication unit for communication with at least one external unit for an exchange of electronic data at least for providing an open-loop and/or closed-loop control of the drive unit. The communication unit is preferably formed as a cableless communication unit. Here, the communication unit may be formed as a WLAN communication unit, as a Bluetooth communication unit, as a radio communication unit, as an RFID communication unit, as an NFC unit, as an infrared communication unit, as a mobile radio network communication unit or the like. Particularly preferably, the communication unit is intended for bidirectional data transmission. In an alternative configuration, the communication unit is formed as a cable-bound communication unit, such as for example as an LAN communication unit, as a USB communication unit or the like. The external unit is preferably formed as a smartphone, which has an app for communication with the communication unit. It is however also conceivable that the external unit is formed as an external, transportable operator control unit, as a permanently installed operator control unit at a workplace of an operator, as a place-of-use synchronization unit permanently installed in a room, which can be controlled by a central station, such as for example as a result of company rules/safety regulations, or as a further centralized or decentralized operator control unit, input station and/or centralized or decentralized terminal that appears appropriate to a person skilled in the art. Consequently, a synchronization of electronic data can be advantageously made possible. If, for example, a power tool comprising the power tool device is put into operation in a synchronization mode, for example by plugging in a rechargeable battery device or when a power supply cable is plugged in, a connection between the communication unit and an external unit is set up at least partially automatically. Settings stored in the external unit are consequently preferably directly transmittable to the power tool comprising the power tool device. These may be individual settings of an operator, such as for example a desired rapid run-up to a set rotational speed and maximum power and/or company rules, such as for example compliance with a safety function in a designated area of company premises or a place of use. Moreover, electronic data can be transmitted by means of the communication unit to the external unit. For example, it is possible here to transmit to a company central office or the like an exposure of an operator to vibration, to check whether an exposure limit is being maintained, and/or possible payment of bonuses and/or a running time and a load, to assess capacity utilization of a power tool. It is also conceivable that the external unit checks for the presence of safety equipment and/or suitable work clothing, such as for example by means of radio frequency identification, wherein, in dependence on detected safety equipment and/or suitable work clothing, the external unit transmits settings for providing open-loop and/or closed-loop control of the drive unit by way of the communication unit to the open-loop and/or closed-loop control unit. By means of the configuration according to the invention, a convenient, in particular centralized, setting of characteristic variables of a power tool comprising the power tool device can advantageously take place.

It is further proposed that the open-loop and/or closed-loop control unit is intended for accessing by means of the communication unit a central database, in which there is stored at least one safety and/or operating area rule, which can be processed by the open-loop and/or closed-loop control unit at least for providing an open-loop and/or closed-loop control of the drive unit. Consequently, the open-loop and/or closed-loop control unit is preferably intended for controlling at least the drive unit of the portable power tool in an open-loop and/or closed-loop manner in dependence on at least one safety and/or operating area rule of an area of an infrastructure. Allowance can be made in particular for a location, such as for example a global position, at which the portable power tool is used within the infrastructure. Moreover, it is conceivable that the open-loop and/or closed-loop control unit is intended for controlling further functions of the portable power tool in an open-loop and/or closed-loop manner, such as for example a safety function (kickback function or the like) in dependence on at least one safety and/or operating area rule of an area of an infrastructure. Moreover, it is conceivable that locations, such as for example construction sites, outside the infrastructure are covered by means of a digital safety and/or operating area rule grid on the basis of GPS data, by means of which an assignment of safety and/or operating area rules for a location outside the infrastructure can be achieved.

The term “central database” is to be understood in particular as defining here a database that is maintained and/or managed centrally by a management unit, such as for example by a building management, by a safety management or the like. Data, in particular electronic data, which define specific rules, regulations, risk potentials, safety categories or the like for at least one area of an infrastructure, in particular an area of a works premises, an area of a workshop or the like, are preferably stored in the central database. In an infrastructure, in particular in an infrastructure of a works premises, there are laboratories, workshops, offices or the like, which have different risk potentials. Here, the facility management (FCM) bears responsibility in particular for technical facilities and/or individual areas of the infrastructure. Risk assessments are preferably carried out regularly by health and safety engineers (HSE) for technical facilities and/or for individual areas of the infrastructure. Consequently, individual component parts of the infrastructure, such as for example individual laboratories, individual workshops and/or individual offices, are preferably assigned specific rules, regulations, safety categories or the like. For example, an assignment that stipulates that high to very high safety standards are to be maintained may be performed. Explosion protection may for example apply here in individual areas of the infrastructure, in particular in certain rooms. Consequently, work during which for example sparks may occur is preferably prohibited in these areas, or only certain power tools are allowed to carry out the work. Furthermore, assignments with moderate to low safety standards are conceivable. Moreover, assignments that concern vibration and/or noise limits are additionally or alternatively conceivable.

The central database is preferably updated at regular time intervals, in particular by an employee of the facility management and/or by a health and safety engineer (HSE). This preferably involves risk assessments being carried out for the individual areas of the infrastructure, such as for example for individual rooms, laboratories, workshops or the like. On the basis of these risk assessments, it is possible to store in the central database corresponding electronic data which, in dependence on a degree of risk, stipulate for the individual areas of the infrastructure use and/or operation characteristic variables relating to the use and/or operation of a portable power tool, such as for example compliance with prescribed rules of behavior, presence of personal protective equipment (PPE), establishment of access authorization, an obligation to provide evidence of further training or instruction. By means of the configuration according to the invention, a high level of user safety can consequently be advantageously achieved, since by means of the open-loop and/or closed-loop control unit there is an automatic inclusion of safety and/or operating area rules. Consequently, a location- and/or rule-dependent open-loop and/or closed-loop control of the portable power tool can be advantageously achieved. Moreover, it is conceivable that, in addition or as an alternative to a communication with the central database, there is a communication, in particular a data exchange, with at least one sensor unit of work clothing, in particular personal protection equipment (PPE), that an operator and/or user is wearing. Consequently, a safety function of the portable power tool can be advantageously further enhanced. Particularly advantageously, a dependable detection of hazardous situations can be made possible as a result of an indication, an active warning, a disabling of the portable power tool or the like. Consequently, an operator of the portable power tool can be advantageously protected from dangers and/or from injuries.

The open-loop and/or closed-loop control unit advantageously adapts at least one parameter stored in the memory unit of the open-loop and/or closed-loop control unit for providing an open-loop and/or closed-loop control of the drive unit in dependence on electronic data transmitted by means of the communication unit. It is conceivable here that the power tool device links up by means of the communication unit for example with other power tool devices that are located in the vicinity, in particular within a range of less than 1 km, preferably less than 500 m and particularly preferably less than 100 m. In this way, electronic data can be transmitted between the power tool device and other power tool devices to set parameters for providing an open-loop and/or closed-loop control of the drive unit. Consequently, the power tool device can preferably be linked up with other power tool devices in the vicinity, wherein setting values of parameters of the other power tool devices for machining workpieces can be learned as a result of the linking up of the power tool device. For example, a foundry dressing shop uses a large number of power tools formed as angle grinders. Newly acquired angle grinders for example can in this case be linked up with angle grinders that are already in use, preferably by means of a Bluetooth protocol, the newly acquired angle grinders learning from the angle grinders that are already in use presettings concerning a kickback stop function, rotational speed behavior, overload protection, etc. This advantageously allows an amount of effort expended by an operator in manually setting a power tool to be kept down. Furthermore, for example, a cabinetmaker's comprising various trades uses various power tools in various applications. By means of a Zig-Bee network, all of the power tools are linked up with one another. For example, a power tool of the cabinetmaker's that is formed as a handheld power drill is used for drilling blind holes or through-holes or for tapping threads in metal components. On the basis of these already existing cases of work, the user is presented with a preselection of these settings from which he can choose. Furthermore, it is conceivable that, by using a link with a location sensor, such as for example a GPS sensor, a case of work can be preselected by the power tool device in dependence on a distance from a location of the handheld power drill. At least partially automatic setting of parameters can advantageously take place for providing an open-loop and/or closed-loop control of the drive unit.

Moreover, a power tool, in particular a portable power tool with a power tool device according to the invention, is proposed. Particularly preferably, the power tool is formed as a portable power tool. A “portable power tool” is to be understood as meaning in particular here a power tool for machining workpieces that can be transported by an operator without a transporting machine. The portable power tool has in particular a mass that is less than 40 kg, preferably less than 10 kg and particularly preferably less than 5 kg. The portable power tool is preferably formed here as an angle grinder. In an alternative configuration, the portable power tool is formed as a hammer drill and/or a chipping hammer. In a further alternative configuration, the portable power tool is formed as a jigsaw. It is however also conceivable that the portable power tool has some other configuration that appears appropriate to a person skilled in the art, such as for example a configuration as a battery-operated power screwdriver, as an impact drill, as a grinder, as a circular saw, as a diamond drill, as a chainsaw, as a saber saw, as a planer, or as a garden tool. By means of the configuration of the power tool according to the invention, an advantageous adaptation to conditions of use can be made possible. Moreover, machining of a workpiece that is set individually to an operator can be advantageously made possible. Consequently, precise, power-optimized machining of a workpiece can be advantageously made possible.

Furthermore, a power tool system with at least one power tool according to the invention and with at least one external unit, in particular an external sensor unit, is proposed. In one configuration of the power tool system, the external unit is formed as an external noise emission sensor unit. It is possible to obtain a noise measurement, by means of which the open-loop and/or closed-loop control unit lowers the rotational speed of the drive unit for example when a prescribed noise limit value is exceeded. The external unit may be formed here for example as a smartphone. Moreover, in an alternative configuration of the power tool system, the external unit is formed as an external flying spark recording unit. Consequently, a maximum distance that sparks fly can be advantageously set in dependence on a recorded instance of flying sparks, in that a rotational speed of the drive unit can be controlled by the open-loop and/or closed-loop control unit in a closed-loop manner to a maximum flying distance of the sparks in dependence on a machining tool, a material and/or an application case. For this purpose, the instance of flying sparks can for example be optically recorded and the rotational speed can be adapted for altering a distance that sparks fly. Consequently, noise-related nuisances and/or damaging effects with respect to surrounding objects are advantageously avoidable and/or reducible.

Furthermore, a method for controlling at least one power tool according to the invention in an open-loop and/or closed-loop manner is provided, the method comprising at least one method step, in which the open-loop and/or closed-loop control unit determines at least one machining tool state and outputs the machining tool state by means of an information output unit and/or makes allowance for it for providing an open-loop and/or closed-loop control of the drive unit of the power tool. Consequently, an operator can be advantageously informed about a state of a machining tool and/or an adaptation of an open-loop and/or closed-loop control of a drive unit to a state of a machining tool can advantageously take place. Consequently, an effective machining of a workpiece can advantageously be made possible. By means of the method according to the invention, an at least substantially automatic setting of operating parameters and/or operating modes of a power tool can be advantageously made possible.

Moreover, it is proposed that the method comprises at least one method step in which allowance is made for at least the drive unit characteristic variable and/or the machining tool characteristic variable for providing an open-loop and/or closed-loop control of the drive unit of the power tool in at least one operating mode of the power tool constantly over an at least substantially entire time in use. Consequently, an at least substantially automatic allowance can be advantageously made for characteristic variables for optimizing an open-loop and/or closed-loop control of a drive unit during machining of a workpiece. Optimum machining of a workpiece can be advantageously achieved.

Moreover, it is proposed that, in particular in at least one operating mode of the portable power tool, the open-loop and/or closed-loop control unit accesses at least partially automatically by means of the communication unit the central database, in which there is stored at least one safety and/or operating area rule, which can be processed by the open-loop and/or closed-loop control unit at least for providing an open-loop and/or closed-loop control of the drive unit. The open-loop and/or closed-loop control unit preferably evaluates the safety and/or operating area rules stored in the central database automatically and interprets the safety and/or operating area rules automatically for providing an open-loop and/or closed-loop control of the portable power tool. Particularly preferably, in addition to access to the central database by means of the communication unit, electronic data can be exchanged with at least one external unit by means of the communication unit. Consequently, a data exchange between the portable power tool comprising the power tool device and further external units can preferably take place, such as for example a data exchange between the portable power tool comprising the power tool device and a sensor unit of work clothing, a smartphone, a laptop, a PC, a handheld device, a tablet, a server or the like. In particular, the characteristic variables recorded by means of the sensor units of the power tool device and/or the data transmitted by means of the communication unit are preferably exchangeable here and/or can be used for providing an open-loop and/or closed-loop control of the portable power tool comprising the power tool device. The communication unit may have and/or use here cable-bound and/or cableless interfaces and/or communication protocols. Interfaces and/or communication protocols may be formed for example as a USB, as a Canbus, as an Ethernet, in particular with a twisted pair of cables (CAT5 or CAT6), as an optical transmission medium, as a KNX, as a Powerline, as an NFC (near field communication), as an RFID (near field communication), as a Zigbee (near field communication), as a Bluetooth, in particular to the standard 4.0 Low Energy (short range), as a WLAN, in particular to the standard 801.11n (medium range), as a GSM or an LTE (mobile radio network), in particular for long ranges, or the like. Preferably, an external unit, in particular a smartphone, is formed as a router, which is intended as a switching location at least between the communication unit of the power tool device and the central database and/or a further external unit. An individually adapted company smartphone should advantageously be used here. By means of the configuration according to the invention, allowance for safety and/or operating area rules can be advantageously made at least partially automatically for providing an open-loop and/or closed-loop control at least of the drive unit. Consequently, a high level of operating convenience and dependable compliance with safety functions can be advantageously ensured.

Furthermore, it is proposed that the open-loop and/or closed-loop control unit uses data recorded by the power tool sensor and/or data transmitted by the communication unit at least for providing an open-loop and/or closed-loop control of the drive unit. The data recorded by the power tool sensor that can be used by the open-loop and/or closed-loop control unit for providing an open-loop and/or closed-loop control of the drive unit can preferably be recorded by means of at least one of the sensor units, in particular by means of all of the sensor units, of the power tool device. Preferably, the data that are transmitted by the communication unit can be transmitted by means of the communication unit to the open-loop and/or closed-loop control unit from an external unit and/or from the central database. It is conceivable here that the data transmitted by the communication unit can be recorded for example by means of at least one sensor unit of work clothing and can be received by means of the communication unit and/or can be directly read out from the central database by means of the communication unit. The sensor units of the power tool device and/or of the external unit preferably comprise in each case at least one sensor element for recording at least one characteristic variable. The sensor element may be formed here for example as a position sensor (magnetic field sensor or the like, for recording the spatial position), as a movement sensor (speed sensor, acceleration sensor, rate of rotation sensor or the like), as a GPS sensor (X, Y, Z on the Earth's surface), as a pressure sensor (strain gage or the like), as a gas sensor (CO2 sensor; carbon monoxide sensor or the like), as a temperature sensor, as a voltage sensor, as a moisture sensor, as a pH sensor, as an air pressure sensor (barometer), as a pulse sensor or the like. By means of the configuration according to the invention, an allowance for location-dependent safety and/or operating area rules can be advantageously made and, moreover, an inclusion of data recorded by the power tool sensor and/or data transmitted by the communication unit can be used for providing an open-loop and/or closed-loop control of the portable power tool. Consequently, a high level of work safety can be advantageously ensured.

It is further proposed that the open-loop and/or closed-loop control unit outputs at least one item of information by means of an information output unit in dependence on data recorded by the power tool sensor and/or data transmitted by the communication unit. Consequently, information can be advantageously output to an operator in order for example to inform the operator about access control to an area of the infrastructure. Consequently, access control to an area of the infrastructure can be advantageously realized. It is conceivable here that for example fire prevention rules stored in the central database have the effect that an operator may only work with a specific portable power tool in defined rooms with approval or when accompanied by a member of the works fire service. Moreover, it is advantageously possible to warn persons at risk in ambient surroundings and/or in direct proximity of the place of use of the portable power tool by means of optical and/or acoustic signals.

Moreover, it is proposed that the open-loop and/or closed-loop control unit controls at least one operating mode setting of the power tool in an open-loop and/or closed-loop manner in dependence on data recorded by the power tool sensor and/or data transmitted by the communication unit. Consequently, optimum operation of the portable power tool comprising the power tool device can be advantageously achieved.

The open-loop and/or closed-loop control unit interprets, combines and/or evaluates preferably the data recorded by the power tool sensor and/or the data transmitted by the communication unit for providing an open-loop and/or closed-loop control of the portable power tool comprising the power tool device. By means of a transmission of data to the central database, it is preferably conceivable that work reports of jobs can be created at least partially automatically and that these can be recorded and/or logged by facility management staff. In this way it can be advantageously documented who worked with what type of portable power tool when, for how long and at which location. If an incident and/or an accident happens, an automatically created log can thus be advantageously used later to demonstrate observance of an obligation to take care.

As a result of establishing risk potentials, safety and/or operating area rules or the like by the health and safety engineers (HSE) and/or the facility management (FCM) for rooms, laboratories or workshops of the infrastructure, corresponding electronic data are stored in the central database. The communication of the portable power tool comprising the power tool device with the central database means that it can be identified, for example by means of locating by GPS coordinates, which portable power tool is to be found where within the infrastructure. In particular in the case of additional operator data transmission, it can in particular be recorded which operator, in particular with what level of training, is located where with which type of portable power tool. In this way it can be recorded if a portable power tool is taken into an area of the infrastructure that is unauthorized for this portable power tool and operation of the portable power tool can be disabled, information can be output to an operator and/or this can be reported to the health and safety engineers (HSE) and/or the facility management (FCM). Consequently, access monitoring can advantageously take place. It can be advantageously monitored and/or checked in which areas of the infrastructure a portable power tool may be used and whether an operator has to present evidence of permission for use. Consequently, a monitoring of rules can advantageously take place with regard to unaccompanied work and/or automatic one-man monitoring can take place by at least one sensor element of the work clothing in combination with sensor units of the power tool device.

It is also conceivable that electronic data which define limit values for ambient conditions, such as for example temperature limit values, air and/or gas concentration values, are stored in the central database by for example a health and safety engineer (HSE) and/or the facility management (FCM). As a result of a transmission of the electronic data from the central database and a transmission of data recorded by the power tool sensor to the central database, monitoring and/or demonstration of compliance with limit values is advantageously possible.

It is conceivable furthermore that an adjustment of a permission for use takes place by means of the electronic data transmitted by the communication unit. Here it is conceivable for example for training and/or instruction of the operator to be demonstrated by an input (chip card, RFID chip or the like) or by an adjustment of an operator identification profile stored in the central database, in order to make it possible for the portable power tool to be put into operation. If it has been put into operation without authorization having been properly demonstrated, the portable power tool can for example be disabled or for example a warning can be issued by means of the information output unit or a central control station can be informed.

Moreover, it is also conceivable that data of the portable power tool, such as for example the running time, vibrations, rechargeable battery capacity, cooling unit power, motor power or the like, can be transmitted by means of the communication unit to an operator-side unit, such as for example a user interface, a wristwatch, a smartphone, data goggles or the like. The data of the portable power tool can also be transmitted to the central database in order for example to be able to monitor compliance with limit values. Moreover, for example, employees of an outside company who are within the infrastructure can be monitored. Consequently, for example, a working time and/or a working location of the employees of the outside company can be logged. Furthermore, it is possible by means of a transmission of electronic data by means of the communication unit preferably for an operator profile to be set up by the open-loop and/or closed-loop control unit. When there is a transmission of data by means of the communication unit, settings of the portable power tool can preferably be performed here automatically by the open-loop and/or closed-loop control unit, such as for example authorization settings, the setting of a preferred motor characteristic curve, the setting of a response behavior of safety functions (kickback function etc.) or the like.

Furthermore, in particular as a result of an adjustment of electronic data from the central database, of data recorded by the power tool sensor and of data recorded by means of at least one sensor unit of an operator's work clothing, automatic monitoring of an obligation to wear personal protective equipment (PPE), which for example comprises a helmet, at least one glove, at least one pair of protective goggles, safety shoes, work pants or the like, and/or monitoring of a restriction of the locations where a portable power tool can be used can be achieved. Here it is conceivable that an emergency switch-off of the portable power tool can be instigated by a central control station in an area of the infrastructure as soon as at least one vital characteristic variable of an operator reaches a value that is critical for an operator.

Moreover, a central update function for the portable power tool can be advantageously made possible by means of a transmission of electronic data from a central database. Furthermore, when maintenance is due, such as for example a change of carbon brushes, can be advantageously transmitted to a central control station.

The power tool device according to the invention, the power tool according to the invention and/or the method according to the invention is/are not to be restricted here to the application and embodiment described above. In particular, the power tool device according to the invention, the power tool according to the invention and/or the method according to the invention may have a number of individual elements, components, units and/or method steps other than the number mentioned herein for achieving a manner of functioning described herein.

### DRAWING

Further advantages emerge from the following description of the drawing. In the drawing, exemplary embodiments of the invention are represented. The drawing, the description and the claims contain numerous features in combination. A person skilled in the art will expediently also consider the features individually and bring them together into further appropriate combinations.

In the Drawing:

FIG. 1 shows a power tool according to the invention, which is formed as an angle grinder, with at least one power tool device according to the invention in a schematic representation,

FIG. 2 shows a schematic representation of the power tool device according to the invention,

FIG. 3 shows a schematic representation of an alternative power tool device according to the invention,

FIG. 4 shows an alternative power tool according to the invention, which is formed as a hammer drill and/or a chipping hammer, with a power tool device according to the invention in a schematic representation,

FIG. 5 shows a further alternative power tool according to the invention, which is formed as a battery-operated screwdriver, with a power tool device according to the invention in a schematic representation and

FIG. 6 shows a further alternative power tool according to the invention, which is formed as a jigsaw, with a power tool device according to the invention in a schematic representation.

### DESCRIPTION OF THE EXEMPLARY EMBODIMENTS

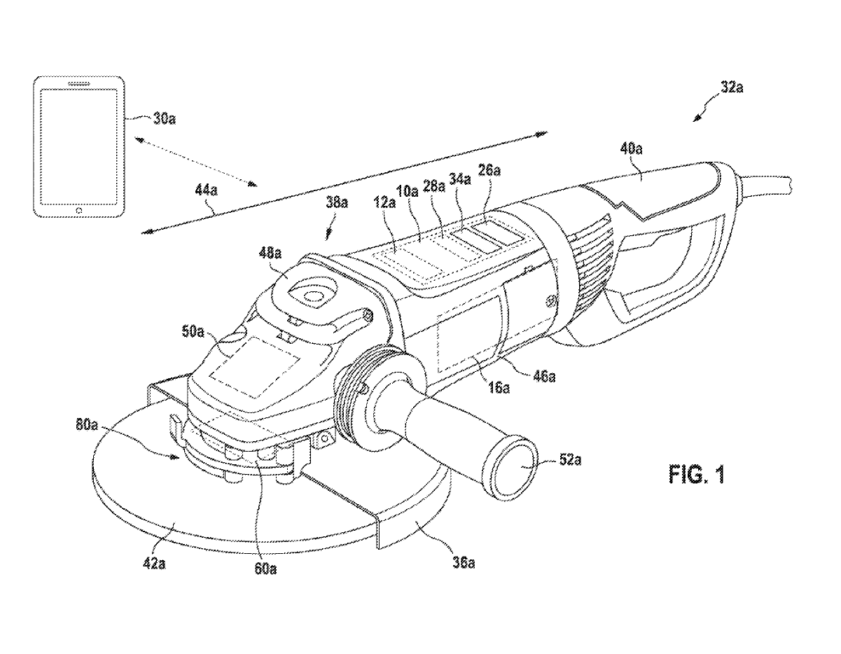

FIG. 1 shows a power tool 32a with at least one power tool device 10a. The power tool 32a is formed as a portable power tool. Here, the power tool 32a is formed as an angle grinder. Consequently, the power tool 32a comprises at least one power tool accessory unit 36a, formed as a protective shroud unit. The power tool 32a also comprises at least one power tool housing 38a and a main handle 40a, which extends on a side of the power tool housing 38a that is facing away from a machining tool 42a in the direction of a main direction of extent 44a of the power tool 32a. The machining tool 42a is formed here as a grinding disk. It is however also conceivable that the machining tool 42a is formed as a cutting or polishing disk. The power tool housing 38a comprises a motor housing 46a for receiving a drive unit 16a of the power tool 32a. The power tool housing 38a further comprises a transmission housing 48a for receiving an output unit 50a of the power tool 32a. The drive unit 16a is intended for driving the machining tool 42a in a rotational manner by way of the output unit 50a. Arranged on the transmission housing 48a is a further power tool accessory unit 52a, formed as an additional handle unit. The power tool accessory unit 52a formed as an additional handle unit extends transversely in relation to the main direction of extent 44a of the power tool 32a.

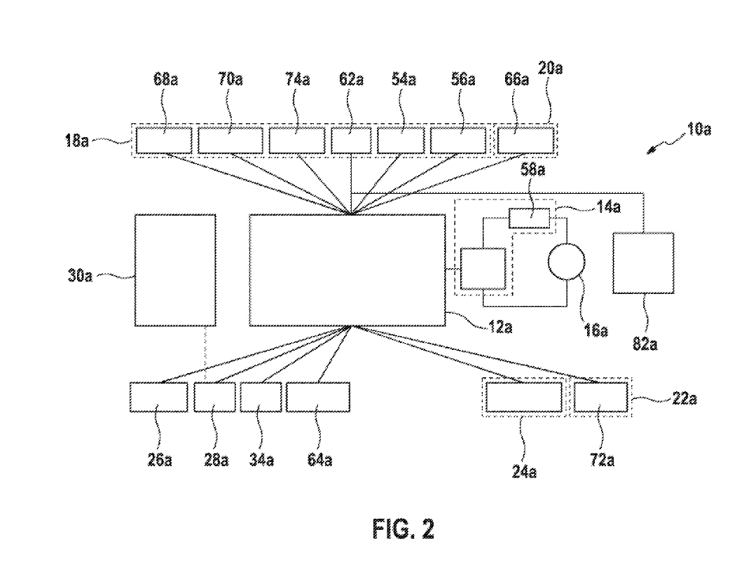

The power tool device 10a is formed as a handheld power tool device. The power tool device 10a preferably comprises a power supply device 82a (FIG. 2). Consequently, the power tool device 10a can be operated independently of a power supply of the power tool 32a. It is however also conceivable that, in an alternative configuration of the power tool device 10a, the power tool device 10a can be supplied with power by means of a power supply device of the power tool 32a. The power tool device 10a further comprises at least one open-loop and/or closed-loop control unit 12a and at least one drive unit sensor unit 14a for recording at least one drive unit characteristic variable, which can be processed by the open-loop and/or closed-loop control unit 12a for at least providing an open-loop and/or closed-loop control of a drive unit 16a of the power tool 32a and/or for providing an output of information to an operator. In at least one operating mode of the power tool 32a, the open-loop and/or closed-loop control unit 12a is intended for providing an open-loop and/or closed-loop control of the drive unit 16a in dependence on the at least one drive unit characteristic variable recorded by means of the drive unit sensor unit 14a.

Furthermore, the power tool device 10a comprises at least one machining tool sensor unit 18a for recording at least one machining tool characteristic variable, which can be processed by the open-loop and/or closed-loop control unit 12a at least for providing an open-loop and/or closed-loop control of the drive unit 16a and/or for providing an output of information to an operator. The open-loop and/or closed-loop control unit 12a is intended for providing an open-loop and/or closed-loop control of the drive unit 16a in dependence on the at least one drive unit characteristic variable recorded by means of the drive unit sensor unit 14a. Here, in at least one operating mode the open-loop and/or closed-loop control unit 12a processes the at least one machining tool characteristic variable recorded by means of the machining tool sensor unit 18a for providing a determination of a tool type of the machining tool 42a arranged on a tool holder 80a of the power tool 32a.

The power tool device 10a further comprises at least one power tool accessory sensor unit 24a for recording at least one power tool accessory characteristic variable, which can be processed by the open-loop and/or closed-loop control unit 12a at least for providing an open-loop and/or closed-loop control of the drive unit 16a and/or for providing an output of information to an operator. In at least one operating mode of the power tool 32a, the open-loop and/or closed-loop control unit 12a is intended for providing an open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 18a and in dependence on the at least one power tool accessory characteristic variable recorded by means of the power tool accessory sensor unit 24a. At least in an initial learning operating mode, the open-loop and/or closed-loop control unit 12a is intended here for providing an at least partially automatic open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 18a and in dependence on the at least one power tool accessory characteristic variable recorded by means of the power tool accessory sensor unit 24a. The initial learning operating mode is automatically activated after the power tool 32a is put into operation, until an idling speed is reached. A centrifugal mass of the machining tool 42a can be determined by means of the open-loop and/or closed-loop control unit 12a by way of at least one inertia sensor 54a of the machining tool sensor unit 18a, at least one torque sensor 56a of the machining tool sensor unit 18a and/or a current sensor 58a of the drive unit sensor unit 14a (FIG. 2). The inertia sensor 54a is preferably formed as a three-axis acceleration sensor. The determined centrifugal mass can be unequivocally assigned to a certain machining tool type and/or to a tool type of the machining tool 42a by way of at least one characteristic map stored in a memory unit (not represented any more specifically here) of the open-loop and/or closed-loop control unit 12a. It is also conceivable that a recording of further machining tool characteristic variables additionally takes place by way of RFID, NFC, scanning a barcode, data matrix codes or the like. Drive unit parameters can be adapted and/or can be changed in dependence on the machining tool 42a determined by the open-loop and/or closed-loop control unit 12a for providing an open-loop and/or closed-loop control of the drive unit 16a.

In the initial learning operating mode of the power tool 32a, a rotational speed that is optimum for the machining tool 42a can be set at least partially automatically by means of the open-loop and/or closed-loop control unit 12a in dependence on a material (steel, stainless steel, stone, concrete, wood etc.) of a workpiece to be machined. For this purpose, the power tool device 10a has at least one workpiece sensor unit 22a for recording at least one workpiece characteristic variable, which can be processed by the open-loop and/or closed-loop control unit 12a at least for providing an open-loop and/or closed-loop control of the drive unit 16a and/or for providing an output of information to an operator. At least in the initial learning operating mode, the open-loop and/or closed-loop control unit 12a is intended here for providing an at least partially automatic open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 18a, in dependence on the at least one power tool accessory characteristic variable recorded by means of the power tool accessory sensor unit 24a and in dependence on the at least one workpiece characteristic variable recorded by means of the workpiece sensor unit 22a.

Furthermore, in the initial learning operating mode of the power tool 32a, abnormalities with regard to vibration of the machining tool 42a during running up to an idling speed of the drive unit 16a can be recorded. As a result, incorrect mounting, wear and/or a defect of the machining tool 42a can be recorded. Consequently, by means of the open-loop and/or closed-loop control unit 12a, information can be output to an operator by way of an information output unit 34a of the power tool device 10a and/or the drive unit 16a can be actively decelerated and/or a power supply to the drive unit 16a can be interrupted. Moreover, as a result of a determination of the machining tool 42a, a rotational speed of the drive unit 16a that is suitable as a maximum for the machining tool 42a can be set. Consequently, at least in the initial learning operating mode, the open-loop and/or closed-loop control unit 12a determines a machining tool state and outputs the machining tool state by means of the information output unit 34a and/or makes allowance for the machining tool state for providing an open-loop and/or closed-loop control of the drive unit 16a of the power tool 32a.

Moreover, the power tool 32a has at least one machining tool securing unit 60a, which comprises at least one securing element (not represented any more specifically here) for securing the machining tool 42a to the tool holder 80a of the power tool 32a. Here, the machining tool sensor unit 18a has at least one securing sensor element 62a, which is intended for monitoring secure fastening of the machining tool 42a to the tool holder 80a. If the securing sensor element 62a records a detached state of the machining tool 42a, a power supply to the drive unit 16a can be interrupted by means of the open-loop and/or closed-loop control unit 12a. Consequently, operation of the drive unit 16a is disabled. It is conceivable that a drive spindle and/or a clamping nut of the power tool 32a has a bore into which the securing element is insertable, in particular is insertable by way of a servomotor, the position of which can be recorded by means of the securing sensor element 62a. Furthermore, it is also conceivable that a securing element formed as a clamping nut can be prestressed by means of an at least partially automatic tightening unit to a defined torque, it being possible for the torque to be recorded by means of the torque sensor 56a.

Furthermore, in one configuration of the power tool device 10a a vibration exciter element 64a (FIG. 2) of the power tool device 10a, by means of which a secure arrangement of the machining tool 42a on the drive spindle can be checked, is arranged in the securing element formed as a clamping nut. The vibration exciter element 64a may be formed as a smart material element, as a piezo element, as an oscillating coil element or as some other exciter element that appears appropriate to a person skilled in the art. Here, the vibration exciter element 64a can be used to set the machining tool 42a in vibration, which can be recorded by means of the machining tool sensor unit 18a and can be evaluated by means of the open-loop and/or closed-loop control unit 12a. The machining tool 42a can furthermore be divided into portions by means of the open-loop and/or closed-loop control unit 12a, it being possible for each portion to be evaluated individually by the open-loop and/or closed-loop control unit 12a with regard to a vibration. Consequently, damage to the machining tool 42a in one portion can be advantageously detected. Further configurations that appear appropriate to a person skilled in the art for recording machining tool characteristic variables are likewise conceivable.

The power tool device 10a further comprises at least one operator sensor unit 20a for recording at least one operator-specific characteristic variable, which can be processed by the open-loop and/or closed-loop control unit 12a at least for providing an open-loop and/or closed-loop control of the drive unit 16a and/or for providing an output of information to an operator. The operator sensor unit 20a comprises at least one operator sensor element 66a (FIG. 2), which is intended for recording at least one operator-specific characteristic variable. The operator sensor element 66a is formed here as a vibration sensor, in particular as a three-axis acceleration sensor. By means of the operator sensor unit 20a, in particular a vibration that acts on an operator can be recorded on the power tool housing 38a and/or on the main handle 40a. By means of the open-loop and/or closed-loop control unit 12a, a rotational speed can be altered when a resonance and/or a maximum vibration value is reached. Moreover, a pressing pressure and/or a pressing force of an operator on the power tool 32a can be recorded by means of the operator sensor unit 20a.

The power tool device 10a further comprises at least one input unit 26a for providing an input of at least one machining characteristic variable, which can be processed by the open-loop and/or closed-loop control unit 12a at least for providing an open-loop and/or closed-loop control of the drive unit 16a. By means of the input unit 26a, at least an open-loop and/or closed-loop control of the drive unit 16a can be influenced by the open-loop and/or closed-loop control unit 12a. Moreover, by means of the input unit 26a, an operating mode of the power tool 32a can be set. The power tool 32a has here at least the initial learning operating mode, a learning operating mode, a reference operating mode, a safety operating mode, a synchronization operating mode and/or an automatic operating mode. At least in the initial learning operating mode, the open-loop and/or closed-loop control unit 12a is intended here for providing an at least partially automatic open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 18a and in dependence on the at least one power tool accessory characteristic variable recorded by means of the power tool accessory sensor unit 24a.

In the learning operating mode, the open-loop and/or closed-loop control unit 12a is intended for providing an at least partially automatic open-loop and/or closed-loop control of the drive unit 16a in dependence on the at least one drive unit characteristic variable recorded by means of the drive unit sensor unit 14a, in dependence on the at least one machining tool characteristic variable recorded by means of the machining tool sensor unit 18a, in dependence on the at least one power tool accessory characteristic variable recorded by means of the power tool accessory sensor unit 24a, in dependence on the at least one operator-specific characteristic variable recorded by means of the operator sensor unit 20a and in dependence on the at least one machining characteristic variable input by means of the input unit 26a. The learning operating mode is carried out here after activation by means of the input unit 26a up until switching over to another operating mode of the power tool 32a or up until switching off of the power tool 32a. As long as the learning operating mode is activated, all of the aforementioned characteristic variables are constantly monitored by means of the respective sensor units and parameters and/or characteristic curves of the drive unit 16a are adapted by means of the open-loop and/or closed-loop control unit 12a.

In the learning operating mode, a machining tool diameter can be monitored at least substantially automatically by means of the machining tool sensor unit 18a during a machining of a workpiece. For this purpose, the machining tool sensor unit 18a comprises at least one machining tool sensor element 68a, which is formed for example as a torque sensor, as a rotational speed sensor, as an optical sensor (light barrier, camera, etc.) or the like. The open-loop and/or closed-loop control unit 12a is intended here to correct a rotational speed to a maximum circumferential speed, such as for example 80 m/s, as a result of a recorded decrease in the machining tool diameter. This advantageously allows a constant cutting speed to be achieved, and consequently a constant rate of work progress. Moreover, in the learning operating mode, a duration of one type of machining can be recorded.

Consequently, if a type of machining is of a short duration, a current limit of the drive unit 16a can be raised by means of the open-loop and/or closed-loop control unit 12a, as for example in the case of a cutting type of machining for profiles etc. This allows a high rate of work progress to be achieved and, due to the short duration, an acceptable overload for the drive unit 16a. If a type of machining is of a long duration, the current limit can be lowered by means of the open-loop and/or closed-loop control unit 12a, in order to achieve low overloading and consequently a long service life of the drive unit 16a. Moreover, a type of machining can be detected by means of the machining tool sensor unit 18a. For this purpose, the machining tool sensor unit 18a comprises at least one additional machining tool sensor element 74a, which is formed as a pressure sensor. By means of the additional machining tool sensor element 74a, which is arranged on the drive spindle, it can be detected whether a roughing operation or a grinding operation is being carried out by means of the machining tool 42a. Moreover, it is conceivable that the machining tool sensor unit 18a comprises a force sensor, which is intended for detecting a type of machining.

Furthermore, in the learning operating mode an upswing of the machining tool 42a can be detected at least substantially automatically by means of the machining tool sensor unit 18a and/or an upswing of a workpiece can be detected at least substantially automatically by means of the workpiece sensor unit 22a. For this purpose, the machining tool sensor unit 18a has a further machining tool sensor element 70a, formed as acceleration sensor, and/or the workpiece sensor unit 22a has a workpiece sensor element 72a, formed as an acceleration sensor. As a result of recording an upswing of the machining tool 42a and/or of the workpiece, a rotational speed of the drive unit 16a can be changed by means of the open-loop and/or closed-loop control unit 12a in such a way that the machining tool 42a and/or the workpiece move(s) out of a critical vibration frequency range (for example in the case of sheet-metal machining). Furthermore, in the learning operating mode a so-called glassing of the machining tool 42a can be detected at least substantially automatically by means of the machining tool sensor unit 18a. As a result of detection of glassing of the machining tool 42a, a deglassing run and/or a cleaning run can be initiated at least substantially automatically by means of the open-loop and/or closed-loop control unit 12a. Here, a low rotational speed of the drive unit 16a, which is overlaid with pulses, can be set. As a result, a cessation of the glassing can be achieved. Consequently, at least in the learning operating mode, allowance is constantly made for at least the drive unit characteristic variable and/or the machining tool characteristic variable for providing an open-loop and/or closed-loop control of the drive unit 16a of the power tool 32a over an at least substantially entire time in use.

In the reference operating mode of the power tool 32a, which can be activated by an operator by means of the input unit 26a, a characteristic curve of the drive unit 16a can be adapted to a recurring machining activity by means of the open-loop and/or closed-loop control unit 12a. This involves carrying out a reference run, in which characteristic variables can be recorded for setting the drive unit 16a by means of the machining tool sensor unit 18a, the workpiece sensor unit 22a, the operator sensor unit 20a and/or the power tool accessory sensor unit 24a. The characteristic variables thus recorded are stored in the memory unit by means of the open-loop and/or closed-loop control unit 12a as a characteristic curve for a machining operation. The drive unit 16a is in this case operated with the stored characteristic curve until a further reference run is carried out or until a new operating mode is selected. The reference operating mode can advantageously be used in the case where an application of the power tool 32a for machining workpieces remains the same, such as for example cutting a workpiece profile that remains the same etc. By means of the open-loop and/or closed-loop control unit 12a, the drive unit 16a can be advantageously set to an optimum operating point and an operator can advantageously achieve an optimum rate of work progress. Moreover, the open-loop and/or closed-loop control unit 12a comprises at least the memory unit, in which there can be stored at least one setting parameter that is dependent at least on at least one previous machining of a workpiece for providing an open-loop and/or closed-loop control of the drive unit 16a. In at least one operating mode, the open-loop and/or closed-loop control unit 12a processes the setting parameter stored in the memory unit to make possible a recurring machining activity. The reference operating mode is activated until a different operating mode is selected by the operator by means of the input unit 26a or until the power tool 32a is switched off.

In the synchronization operating mode of the power tool 32a, a connection to an external unit 30a can be established at least substantially automatically. For this purpose, the power tool device 10a comprises at least one communication unit 28a for communication with at least the external unit 30a for an exchange of electronic data at least for providing an open-loop and/or closed-loop control of the drive unit 16a. Maps of characteristic curves can be transmitted here by means of the communication unit 28a for providing an open-loop and/or closed-loop control of the drive unit 16a. Stored here in the external unit 30a are parameters and/or characteristic curves for providing an open-loop and/or closed-loop control of the drive unit 16a, which can be transmitted to the open-loop and/or closed-loop control unit 12a as a result of a connection between the external unit 30a and the communication unit 28a. The parameters and/or characteristic curves may be individual settings of an operator, such as for example a rapid run-up to a desired rotational speed of the drive unit 16a, stipulations by a company, such as for example that machining of workpieces can only be carried out in a dangerous area if safety accessory requirements are met, or the like. Here, the power tool 32a and the external unit 30a form a power tool system.

Moreover, adjustment of a job assignment for an operator can be achieved here in the synchronization operating mode with a machining job assignment stored in the external unit 30a. Adjustment of the type of tool, type of machining and/or type of workpiece mentioned in the job assignment takes place. Moreover, in the synchronization operating mode, an access authorization can be issued and/or, in dependence on an access authorization, the action of putting the power tool 32a into operation can be disabled and/or enabled.

Moreover, in the synchronization operating mode, vibration values, which can be recorded by means of the operator sensor unit 20a and can be used for the payment of bonuses or for monitoring an amount of vibration to which an operator is exposed per day, can be transmitted to the external unit 30a. Furthermore, a running time and a type of loading of the power tool 32a can be recorded and can be transmitted to the external unit 30a. As a result, a proposal for a different machining tool and/or a different power tool can be output by means of the information output unit 34a. Furthermore, in particular in the synchronization operating mode, the open-loop and/or closed-loop control unit 12a adapts at least one parameter stored in a memory unit of the open-loop and/or closed-loop control unit 12a in dependence on electronic data transmitted by means of the communication unit 28a for providing an open-loop and/or closed-loop control of the drive unit 16a.

Furthermore, the open-loop and/or closed-loop control unit 12a is intended for accessing by means of the communication unit 28a a central database, in which there is stored at least one safety and/or operating area rule, which can be processed by the open-loop and/or closed-loop control unit 12a at least for providing an open-loop and/or closed-loop control of the drive unit 16a. Here, in at least one operating mode, the open-loop and/or closed-loop control unit 12a accesses at least partially automatically by means of the communication unit 28a the central database, in which there is stored at least one safety and/or operating area rule that can be processed by the open-loop and/or closed-loop control unit 12a at least for providing an open-loop and/or closed-loop control of the drive unit 16a. Consequently, the open-loop and/or closed-loop control unit 12a uses data recorded by the power tool sensor and/or data transmitted by the communication unit at least for providing an open-loop and/or closed-loop control of the drive unit 16a. Furthermore, the open-loop and/or closed-loop control unit 12a outputs at least one item of information by means of an information output unit 34a of the power tool device 10a in dependence on data recorded by the power tool sensor and/or data transmitted by the communication unit, in particular for informing an operator about a state of the power tool and/or for warning that there is a risk. Moreover, the open-loop and/or closed-loop control unit 12a controls at least one operating mode setting of the power tool in an open-loop and/or closed-loop manner in dependence on data transmitted by the communication unit.

In the automatic operating mode of the power tool 32a, the aforementioned operating modes are selected automatically by the open-loop and/or closed-loop control unit 12a, in particular in dependence on recorded characteristic variables that can be determined by means of the aforementioned sensor units. In the automatic operating mode there is an at least substantially automatic open-loop and/or closed-loop control of the drive unit 16a by the open-loop and/or closed-loop control unit 12a in dependence on the machining tool sensor unit 18a, on the operator sensor unit 20a, on the workpiece sensor unit 22a and on the power tool accessory sensor unit 24a.

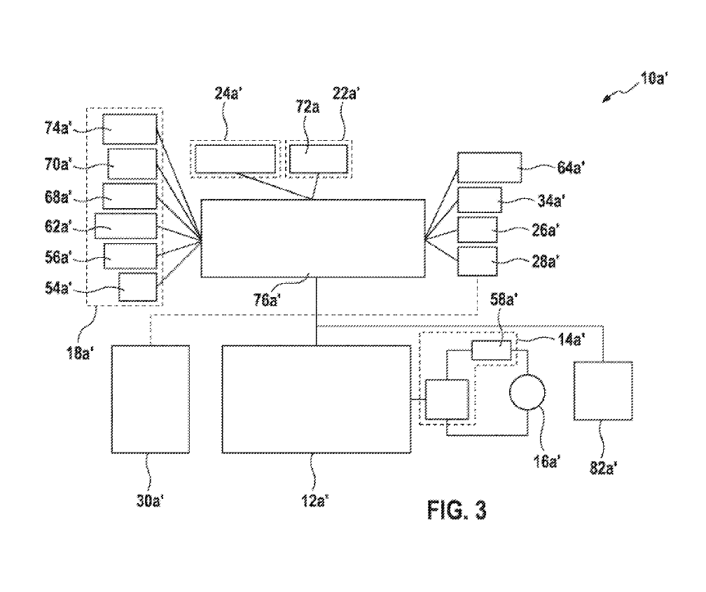

In FIG. 3, an alternative power tool device 10a′ is represented. The alternative power tool device 10a′ has an at least substantially analogous configuration in comparison with the power tool device 10a schematically represented in FIG. 2. As a difference from the power tool device 10a schematically represented in FIG. 2, the alternative power tool device 10a′ schematically represented in FIG. 3 has at least one preprocessing unit 76a′. The preprocessing unit 76a′ is intended to organize a communication of a number of sensor elements and/or sensor units of the alternative power tool device 10a′ with one another and/or with an open-loop and/or closed-loop control unit 12a′ of the alternative power tool device 10a′. The preprocessing unit 76a′ is intended here to combine individual sensor signals and make preliminary decisions. A communication between the preprocessing unit 76a′ and the open-loop and/or closed-loop control unit 12a′ may take place here in a cableless and/or cable-bound manner.

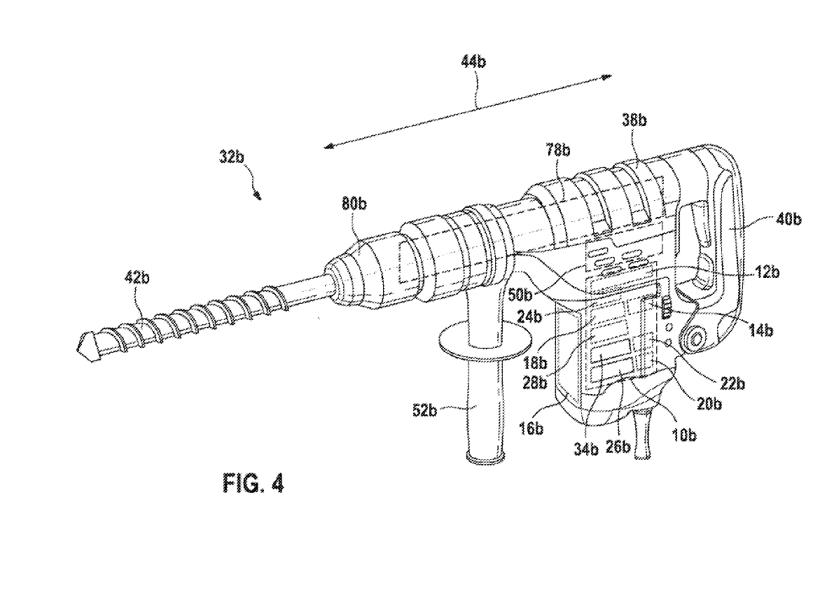

FIGS. 4 to 6 show further exemplary embodiments of the invention. The following description and the drawing are substantially confined to the differences between the exemplary embodiments, it being possible in principle also to refer to the drawing and/or the description of the other exemplary embodiments, in particular of FIGS. 1 to 3, with respect to components with the same designations, in particular with respect to components with the same reference numerals. To distinguish between the exemplary embodiments, the letter a has been added after the reference numerals of the exemplary embodiment in FIGS. 1 to 3. In the exemplary embodiments of FIGS. 4 to 6, the letter a has been substituted by the letters b or c.

FIG. 4 shows a power tool 32b with at least one power tool device 10b. The power tool 32b is formed as a portable power tool. The power tool 32b is formed here as a hammer drill and/or a chipping hammer. The power tool 32b comprises at least one percussion mechanism device 78b. The power tool 32b further comprises a power tool housing 38b, arranged on which, in a front region, is a tool holder 80b of the power tool 32b for receiving a machining tool 42b. On a side facing away from the front region, the power tool 32b comprises a main handle 40b for guiding the power tool 32b and for transmission of a force, in particular a pressing force, from an operator to the power tool 32b. The power tool 32b is further formed with a detachable additional handle unit. The additional handle unit may be detachably fastened here to the power tool housing 38b by way of a snap-in connection or other connections that appear appropriate to a person skilled in the art.

For generating a drive moment and for generating a percussive impulse by means of the percussion mechanism device 78b, the power tool 32b has a drive unit 16b. By way of an output unit 50b of the power tool 32b, a drive moment of the drive unit 16b for generating a percussive impulse is transmitted to the percussion mechanism device 78b. It is however also conceivable that the power tool 32b is formed in such a way that it is decoupled from the output unit 50b and the drive unit 16b acts substantially directly on the percussive mechanism device 78b for generating a percussive impulse. A percussive impulse of the percussion mechanism device 78b is generated in a way that is known to a person skilled in the art. A rotating drive of the tool holder 80b and consequently of the machining tool 42a is likewise produced in a way that is already known to a person skilled in the art. In an alternative configuration of the power tool 32b, an impact frequency is decoupled from a rotational speed of the machining tool 42b. For this purpose, the power tool 32b comprises at least one percussion mechanism device drive unit for generating a percussive impulse by means of the percussion mechanism device 78b and the drive unit 16b for generating a rotational movement of the machining tool 42b. The percussion mechanism device drive unit and the drive unit 16b can be activated independently of one another. The percussion mechanism device drive unit is preferably formed as an electrical linear motor.

Consequently, a high efficiency can be advantageously achieved. An impact energy can be advantageously adapted in dependence on a material of a workpiece to be machined, such as for example a small impact energy and a high impact frequency in the case of soft materials or a high impact energy with a low impact frequency in the case of hard materials.

By analogy with the power tool device 10a described in the description of FIGS. 1 to 3, the power tool device 10b comprises at least one machining tool sensor unit 18b, at least one operator sensor unit 20b, at least one workpiece sensor unit 22b, at least one power tool accessory sensor unit 24b, at least one input unit 26b, at least one communication unit 28b and at least one information output unit 34b. Preferably, an impact energy can be output to an operator by means of the information output unit 34b. For recording an impact energy, the machining tool sensor unit 18b comprises for example at least one force sensor element, at least one time measuring sensor element and/or at least one speed sensor element for recording a speed of an impact element of the percussion mechanism device 78b that is formed as a riveting die. Alternatively, it is also conceivable that an impact energy can be calculated by recording a drive unit rotational speed of the drive unit 16b and by an adjustment of the latter with a characteristic curve stored in a memory unit of an open-loop and/or closed-loop control unit 12b of the power tool device 10b. The maximum impact energy can be set here by means of the input unit 26b. Consequently, the impact energy can be advantageously limited in the case of sensitive materials (for example tiles), in order to avoid damage to a workpiece that is to be machined.

By means of the input unit 26b, an operating mode of the power tool 32b can be set. The power tool 32b has here at least an initial learning operating mode, a learning operating mode, a reference operating mode, a synchronization operating mode and/or an automatic operating mode. In the initial learning operating mode, a machining tool characteristic variable can be recorded by means of the machining tool sensor unit 18b. Here, a machining-tool diameter of the machining tool 42b arranged in the tool holder 80b can be determined by way of a machining tool sensor element 68b formed as a displacement sensor and/or as a distance sensor. Moreover, in the initial learning operating mode, a length and a mass of the machining tool 42b can be determined by way of a vibration analysis. Here, a vibration of the machining tool 42b can be generated as a result of activating the percussion mechanism device 78b or an additional actuator of the machining tool sensor unit 18b. The vibration of the machining tool 42b can be recorded by means of a further machining tool sensor element 68b, which is formed as an acceleration sensor. In a characteristic map stored in a memory unit of the open-loop and/or closed-loop control unit 12b, length-dependent vibration data are stored. Moreover, it is conceivable that there is a recording of further machining tool characteristic variables additionally by way of RFID, NFC, scanning a barcode, DataMatrix code or the like. By means of a recording of vibrations by the further machining tool sensor element 68b, moreover, resonances or untypical vibrations can be detected. As a result, a defect or an incorrectly mounted machining tool 42b can be detected and can be output to an operator by means of the information output unit 34b. On the basis of a detected machining tool 42b, a rotational speed, a number of percussions, an impact energy or a slip moment for example can be set by means of the open-loop and/or closed-loop control unit 12b.

Furthermore, the machining tool sensor unit 18b comprises at least one distance measuring sensor element (not represented any more specifically here), such as for example an ultrasonic distance measuring sensor element, a laser distance measuring sensor element, or the like. By means of the distance measuring sensor element, automatic switching off of the drive unit 16b when a prescribed drilling depth is reached can be realized by way of the open-loop and/or closed-loop control unit 12b of the power tool device 10b. It is conceivable here that an initial drilling is automatically detectable, for example in dependence on a torque and/or a pressing pressure.

In the learning operating mode, an advancing force exerted by an operator can be recorded by means of the operator sensor unit 20b. As a result, a degree of wear of the machining tool 42b can be determined in dependence on a rate of work progress. This degree of wear can be output to an operator by means of the information output unit 34b, so that the attention of an operator can be drawn to a tool change. Moreover, in the learning operating mode, a pressing pressure exerted by an operator can be measured by means of the operator sensor unit 20b and a rate of work progress on the workpiece can be measured by means of the workpiece sensor unit 22b, in order to set the impact frequency of the percussion mechanism device 78b by means of the open-loop and/or closed-loop control unit 12b.

Furthermore, the power tool device 10b comprises at least one ambient sensor unit (not represented any more specifically here), which comprises at least one position sensor element for recording an inclination of the power tool 32b in relation to a horizontal. Furthermore, the power tool device 10b comprises at least one position controlling unit, such as for example a gyroscope unit, which for example controls an alignment of the power tool 32b in relation to a horizontal in a closed-loop manner in dependence on at least one characteristic variable recorded by means of the position sensor element. Consequently, when there is an unwanted positional deviation, additional stabilizing forces can advantageously act on the power tool 32b. Maintenance of a preset drilling angle, preferably horizontal or vertical, can be advantageously achieved. With regard to further features of the power tool device 10b, reference may be made to the power tool device 10a described in the description of FIGS. 1 to 3.

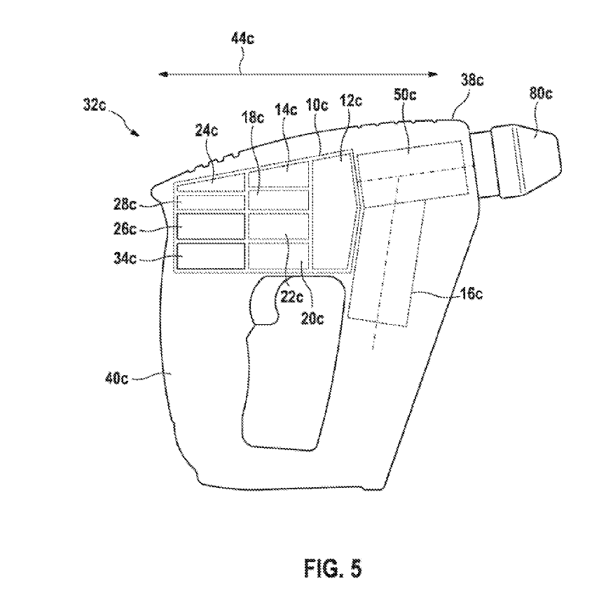

FIG. 5 shows a power tool 32c with at least one power tool device 10c. The power tool 32c is formed as a portable power tool. The power tool 32c is formed here as a battery-operated screwdriver. The power tool 32c comprises at least one power tool housing 38c, arranged on which, in a front region, is a tool holder 80c of the power tool 32c for receiving a machining tool (not represented any more specifically here). On a side facing away from the front region, the power tool 32c comprises a main handle 40c for guiding the power tool 32c and for transmission of a force, in particular a pressing force, from an operator to the power tool 32c. The power tool 32c has a drive unit 16c for generating a drive moment. A drive moment of the drive unit 16c for generating a rotational movement is transmitted to the tool holder 80c by way of an output unit 50c of the power tool 32c. It is however also conceivable that the power tool 32c is formed in such a way that it is decoupled from the output unit 50c and the drive unit 16c acts substantially directly on the tool holder 80c for generating a rotational movement. A rotating drive of the tool holder 80c and of the machining tool is consequently produced in a way that is already known to a person skilled in the art.

By analogy with the power tool device 10a described in the description of FIGS. 1 to 3, the power tool device 10c comprises at least one machining tool sensor unit 18c, at least one operator sensor unit 20c, at least one workpiece sensor unit 22c, at least one power tool accessory sensor unit 24c, at least one input unit 26c, at least one communication unit 28c and at least one information output unit 34c. By means of the information output unit 34c, a number of revolutions of a machining tool (not represented any more specifically here) arranged in a tool holder 80c of the power tool 32c in relation to the power tool housing 38c can be output. For recording a number of revolutions of the machining tool, the machining tool sensor unit 18c comprises at least one rotational speed sensor element (not represented any more specifically here). The rotational speed sensor element may be formed here as an optical sensor element or as a mechanical sensor element. By a definition of threshold values, it can advantageously be defined when a screwing operation begins, and consequently a revolution count begins, in order not to include idling in the count. By means of inputting a type of screw (for example M10) using the input unit 26c, a screwing-in depth can also be calculated and can be output by means of the information output unit 34c. Moreover, the machining tool sensor unit 18c comprises at least one torque sensor element (not represented any more specifically here) for recording a torque of the machining tool, acting for example on a screw. Consequently, when a maximum torque previously set by means of the input unit 26c is reached or exceeded, the drive unit 16c can be automatically switched off. It is possible in this way for example to counteract a seizing behavior in the case of a screw connection, in that, when the set maximum torque is reached, the machining tool and consequently a screw are turned for example a further 90° . A torque can be recorded here by means of the torque sensor element or it can be calculated by means of an open-loop and/or closed-loop control unit 12c of the power tool device 10c in dependence on drive unit currents, drive unit voltages, drive unit temperatures or the like and be output by means of the information output unit 34c.

By means of the input unit 26c, an operating mode of the power tool 32c can be set. The power tool 32c has here at least an initial learning operating mode, a learning operating mode, a reference operating mode, a synchronization operating mode and/or an automatic operating mode. In the initial learning operating mode, a machining tool characteristic variable can be recorded by means of the machining tool sensor unit 18c. A machining tool diameter of the machining tool arranged in the tool holder 80c can be determined by way of a machining tool sensor element 68c formed as a displacement sensor and/or a distance sensor. Moreover, in the initial learning operating mode, a length and a mass of the machining tool can be determined by way of a vibration analysis. The vibration of the machining tool can be recorded by means of a further machining tool sensor element 68c, which is formed as an acceleration sensor. In a characteristic map stored in a memory unit of the open-loop and/or closed-loop control unit 12c, length-dependent vibration data are stored. Moreover, it is conceivable that there is a recording of further machining tool characteristic variables additionally by way of RFID, NFC, scanning a barcode, DataMatrix code or the like. By means of a recording of vibrations by the further machining tool sensor element 68c, moreover, resonances or untypical vibrations can be detected. As a result, a defect or an incorrectly mounted machining tool can be detected and can be output to an operator by means of the information output unit 34c. On the basis of a detected machining tool 42c, a rotational speed and/or a slip moment for example can be set by means of the open-loop and/or closed-loop control unit 12c. Furthermore, an interruption of a form fit between a screw and the machining tool arranged in the tool holder 80c can be detected for example by means of the further machining tool sensor element 68c, in that vibrations that are produced by the machining tool slipping out from the screw can be recorded. When an interruption of a form fit between a screw and the machining tool arranged in the tool holder 80c is detected, the open-loop and/or closed-loop control unit 12c reduces the rotational speed of the drive unit, in order for example to make easy reinsertion of the machining tool into the screw possible. After inserting the machining tool into the screw, the rotational speed of the drive unit can be increased again automatically or manually.

In the learning operating mode, an advancing force exerted by an operator can be recorded by means of the operator sensor unit 20c. As a result, a degree of wear of the machining tool can be determined in dependence on a rate of work progress. This degree of wear can be output to an operator by means of the information output unit 34c, so that the attention of an operator can be drawn to a tool change. Moreover, in the learning operating mode, a pressing pressure exerted by an operator can be measured by means of the operator sensor unit 20c and a rate of work progress on the workpiece can be measured by means of the workpiece sensor unit 22c, in order to set the rotational speed, torque and/or rotational impulse of the drive unit 16c by means of the open-loop and/or closed-loop control unit 12c.

Furthermore, in the learning operating mode, a pressing pressure of the machining tool against a workpiece can be recorded by means of the machining tool sensor unit 18c, in the case of a low pressing pressure a rotational speed being slowly increasable or a placing function being activatable. As a result of slowly running up a rotational speed, the placing function can advantageously avoid slipping off of the machining tool when it is placed on a workpiece, such as for example in the case of smooth, hard surfaces. Moreover, in the learning operating mode, slipping through of a machining tool formed as a screw bit can be recorded by means of the machining tool sensor unit 18c through a fluctuating progression in the rise in rotational speed and/or a torque. Here, a rotational speed of the drive unit 16c can be increased slowly by means of the open-loop and/or closed-loop control unit 12c. Moreover, an output of information or switching off are likewise conceivable as a result of slipping through being detected.

In the synchronization operating mode, a connection 7between the open-loop and/or closed-loop control unit 12c and a charger (not represented any more specifically here) can be established by means of the communication unit 28c. It can be evaluated by means of the open-loop and/or closed-loop control unit 12c when a rechargeable battery arranged on the power tool 32c is discharged and when a rechargeable battery arranged in the charger is fully charged. It can consequently be extrapolated when the rechargeable battery that is in use is discharged and, according to requirements, the second rechargeable battery must be charged sparingly or rapidly.

In the automatic operating mode, a drive unit rotational speed and/or a drive unit torque is variable for example in the case of a screwing operation, in order for example to realize a percussive function and/or to loosen screws. It is conceivable here that the power tool 32c comprises at least one coupling element (not represented any more specifically here), the drive unit 16c being able to gain momentum as a result of coupling play (transmission play), and consequently being able to produce a rotational impulse on the machining tool by kinetic energy. With regard to further features of the power tool device 10c, reference may be made to the power tool device 10a described in the description of FIGS. 1 to 3.

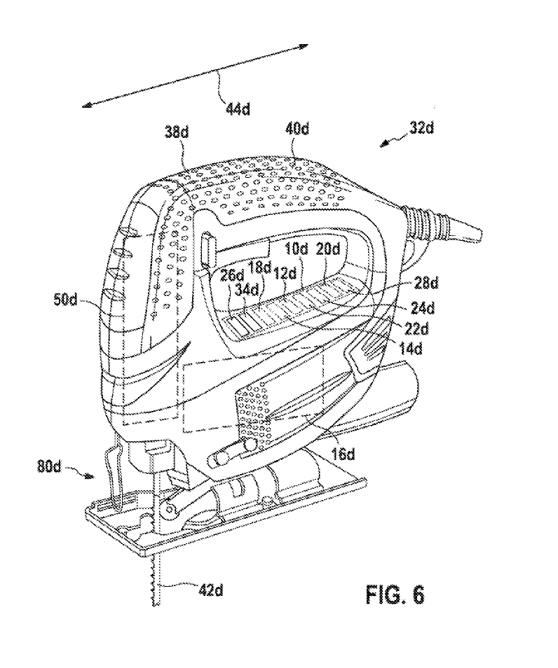

FIG. 6 shows a power tool 32d with at least one power tool device 10d. The power tool 32d is formed as a portable power tool. Here, the power tool 32d is formed as a jigsaw. The power tool 32d has a power tool housing 38d, which encloses a drive unit 16d of the power tool 32d and an output unit 50d of the power tool 32d. The drive unit 16d and the output unit 50d are intended for driving in an oscillating manner a machining tool 42d clamped in a tool holder 80d of the power tool 32d. Here, the machining tool 42d is driven in an oscillating manner substantially perpendicularly in relation to a machining direction. The machining tool 42d is formed as a jigsaw blade. It is however also conceivable that the machining tool 42d is formed by some other machining tool that appears appropriate to a person skilled in the art. An oscillating drive of the machining tool 42d takes place here in a way that is already known to a person skilled in the art.

By analogy with the power tool device 10a described in the description of FIGS. 1 to 3, the power tool device 10d comprises at least one machining tool sensor unit 18d, at least one operator sensor unit 20d, at least one workpiece sensor unit 22d, at least one power tool accessory sensor unit 24d, at least one input unit 26d, at least one communication unit 28d and at least one information output unit 34d.

By means of the input unit 26d, an operating mode of the power tool 32c can be set. The power tool 32d has here at least an initial learning operating mode, a learning operating mode, a reference operating mode, a synchronization operating mode and/or an automatic operating mode. In the initial learning operating mode, a machining tool characteristic variable can be recorded by means of the machining tool sensor unit 18d. An oscillation of the machining tool 42d can be generated here as a result of activation of the drive unit 16d or of an additional actuator of the machining tool sensor unit 18d. The oscillation of the machining tool 42d can be recorded by means of a machining tool sensor element 68d, which is formed as an acceleration sensor. In a characteristic map stored in a memory unit of an open-loop and/or closed-loop control unit 12d of the power tool device 10d, length-dependent vibration data are stored. Moreover, it is conceivable that there is a recording of further machining tool characteristic variables additionally by way of RFID, NFC, scanning a barcode, DataMatrix code or the like. By means of a recording of vibrations by the machining tool sensor element 68d, moreover, resonances or untypical vibrations can be detected. As a result, a defect or an incorrectly mounted machining tool 42d can be detected and can be output to an operator by means of the information output unit 34d. On the basis of a detected machining tool 42d, a stroke frequency, a stroke amplitude, an orbital stroke or or a slip moment for example can be set by means of the open-loop and/or closed-loop control unit 12b.

In the learning operating mode, an advancement characteristic variable can be recorded by means of the operator sensor unit 20d. For this purpose, the operator sensor unit 20d has an acceleration sensor. As a result, it can be recorded by means of the operator sensor unit 20d whether the power tool 32d is being operated with great advancement or with little advancement and/or whether a curved cut or a straight cut is being carried out. Consequently, an orbital stroke parameter can be set by means of the open-loop and/or closed-loop control unit 12d in dependence on the characteristic variable recorded by means of the operator sensor unit 20d. Here it is possible for example to set a high orbital stroke in the case of a quick, straight cut; in the case of a curved cut with small radii, the orbital stroke can be deactivated etc. In addition, it is also possible for the orbital stroke to be set in dependence on the recorded machining tool 42d and in dependence on a material of a workpiece to be machined. Here it is possible for example for a great orbital stroke to be set for a coarse jigsaw blade for a rapid rate of work progress. In addition, a stroke frequency is also adaptable by means of the open-loop and/or closed-loop control unit 12d so as to correspond to recorded characteristic variables.

Furthermore, in the learning operating mode, a hardness and/or a density of a material of a workpiece to be machined can be determined by means of the workpiece sensor unit 22d. If the density is known, a thickness of the workpiece can also be determined on the basis of at least one operating force that is acting. Furthermore, a temperature of the machining tool 42d can be determined by means of the workpiece sensor unit 22d. Here, a risk of overheating can be output to an operator by means of the information output unit 34d and/or a cooling air stream can be directed onto the machining tool 42d by means of the open-loop and/or closed-loop control unit 12d. With regard to further features of the power tool device 10d, reference may be made to the power tool device 10a described in the description of FIGS. 1 to 3.

1. A power tool device, comprising:
at least one open-loop and/or closed-loop control unit;
at least one drive unit sensor unit configured to record at least one drive unit characteristic variable, which can be processed by the open-loop and/or closed-loop control unit at least for providing an open-loop and/or closed-loop control of a drive unit of a power tool and/or for providing an output of information to an operator; and
at least one machining tool sensor unit configured to record at least one machining tool characteristic variable, which can be processed by the open-loop and/or closed-loop control unit at least for providing an open-loop and/or closed-loop control of a drive unit and/or for providing an output of information to an operator.

2. The power tool device as claimed in claim 1, wherein in at least one operating mode the open-loop and/or closed-loop control unit processes the at least one machining tool characteristic variable recorded with the machining tool sensor unit for providing a determination of a tool type of a machining tool arranged on a tool holder of the power tool.

3. The power tool device as claimed in claim 1, wherein the open-loop and/or closed-loop control unit comprises at least one memory unit, in which at least one setting parameter that is dependent at least on at least one previous machining of a workpiece can be stored for providing an open-loop and/or closed-loop control of the drive unit.

4. The power tool device as claimed in claim 1, further comprising:
at least one operator sensor unit configured to record at least one operator-specific characteristic variable, which can be processed by the open-loop and/or closed-loop control unit at least for providing an open-loop and/or closed-loop control of the drive unit and/or for outputting information to an operator.

5. The power tool device as claimed in claim 1, further comprising:
at least one workpiece sensor unit configured to record at least one workpiece characteristic variable, which can be processed by the open-loop and/or closed-loop control unit at least for providing an open-loop and/or closed-loop control of the drive unit and/or for outputting information to an operator.

6. The power tool device as claimed in claim 1, further comprising:
at least one power tool accessory sensor unit configured to record at least one power tool accessory characteristic variable, which can be processed by the open-loop and/or closed-loop control unit at least for providing an open-loop and/or closed-loop control of the drive unit and/or for outputting information to an operator.

7. The power tool device as claimed in claim 1, further comprising:
at least one input unit configured to input at least one machining characteristic variable, which can be processed by the open-loop and/or closed-loop control unit at least for providing an open-loop and/or closed-loop control of the drive unit.

8. The power tool device as claimed in claim 1, further comprising:
at least one communication unit configured to communicate with at least one external unit for an exchange of electronic data at least for providing an open-loop and/or closed-loop control of the drive unit.

9. The power tool device as claimed in claim 8, wherein the open-loop and/or closed-loop control unit is configured to access a central database with the at least one communication unit, in which there is stored at least one safety and/or operating area rule, which can be processed by the open-loop and/or closed-loop control unit at least for providing an open-loop and/or closed-loop control of the drive unit.

10. The power tool device as claimed in claim 8, wherein the open-loop and/or the closed-loop control unit is configured to adapt at least one parameter stored in a memory unit of the open-loop and/or closed-loop control unit for providing an open-loop and/or closed-loop control of the drive unit in dependence on electronic data transmitted with the communication unit.

11. The power tool device as claimed in claim 1, wherein the power tool device is included in a power tool.

12. A power tool system comprising:
at least one power tool including a power tool device; and
at least one external unit,
wherein the power tool device includes
at least one open-loop and/or closed-loop control unit,
at least one drive unit sensor unit configured to record at least one drive unit characteristic variable, which can be processed by the open-loop and/or closed-loop control unit at least for providing an open-loop and/or closed-loop control of a drive unit of a power tool and/or for providing an output of information to an operator, and
at least one machining tool sensor unit configured to record at least one machining tool characteristic variable, which can be processed by the open-loop and/or closed-loop control unit at least for providing an open-loop and/or closed-loop control of a drive unit and/or for providing an output of information to an operator.

13. A method for controlling at least one power tool in an open-loop and/or closed-loop manner, comprising:
determining with an open-loop and/or closed-loop control unit at least one machining tool state;
outputting the determined machining tool state with an information output unit and/or making allowance for it for providing an open-loop and/or closed-loop control of a drive unit of the power tool.

14. The method as claimed in claim 13, further comprising:
making allowance for at least a drive unit characteristic variable and/or a machining tool characteristic variable for providing an open-loop and/or closed-loop control of the drive unit of the power tool in at least one operating mode of the power tool constantly over an at least substantially entire time in use.

15. The method as claimed in claim 13, comprising:
accessing at least partially automatically a central database with the open-loop and/or closed-loop control unit, in at least one operating mode, using a communication unit the central database configured to store at least one safety and/or operating area rule, which can be processed by the open-loop and/or closed-loop control unit at least for providing an open-loop and/or closed-loop control of the drive unit.

16. The method as claimed in claim 15, further comprising:
using data recorded by a power tool sensor and/or data transmitted by the communication unit at least for providing an open-loop and/or closed-loop control of the drive unit.

17. The method as claimed in claim 16, further comprising:
outputting at least one item of information with an information output unit in dependence on data recorded by the power tool sensor and/or data transmitted by the communication unit.

18. The method as claimed in claim 16, further comprising:
controlling at least one operating mode setting of the power tool in an open-loop and/or closed-loop manner in dependence on data recorded by the power tool sensor and/or data transmitted by the communication unit.
